(19) United States
(12) Patent Application Publication
(10) Pub. No.: US 2023/0363430 A1
(43) Pub. Date: Nov. 16, 2023

(54) ENHANCED CRAB BITE TM TYPES OF CULINARY SEASONING FORMULATION PROCESSES, PRODUCTS AND METHODOLOGIES

(71) Applicant: Seafood Boil, dba Crab-Bite, Anaheim, CA (US)

(72) Inventors: Linda Thai, Mission Viejo, CA (US); Shawn Cao, Anaheim, CA (US)

(21) Appl. No.: 18/318,058

(22) Filed: May 16, 2023

Related U.S. Application Data
(60) Provisional application No. 63/342,249, filed on May 16, 2022.

(51) Int. Cl. A23L 27/14; A23L 27/12; A23L 27/30

(52) U.S. Cl. CPC A23L 27/14; A23L 27/13; A23L 27/30

(57) ABSTRACT

Novel enhanced spice systems evenly coat food substrates when combined with heat, feature a plurality of peppers as complements to the base profile, and are scalable as liquid and dry spice packaged goods in unit dose and volume.

### FIELD

The present disclosures relate to the fields of culinary seasoning formulations and flavor delivery paradigms. In particular, the instant inventions leverage optimized flavor profiles locked into both dry and wet scalable deliverables, in individual and group volumes, and delivery vehicles for flagship peppers.

### BACKGROUND OF THE DISCLOSURES

Spices have existed since recorded human history began. However, technology advances now enable precise formulations to address numerous needs. What is needed are flavor profiles that can be sealed up to sell and mass produced without losing flavor profiles.

In general, prior art failures have lacked the ability to fully capture spice profiles and scale them for consumption and packaging.

By addressing both packaging and direct consumption, longstanding needs in the field have been addressed. Prior to the instant teaches, the features of a desired pepper could not be highlighted and produced to eat and savored for later on.

### DETAILED DESCRIPTION OF PREFERRED EMBODIMENTS

Briefly stated, there is provided a formula for producing a Cajun sauce base including modified cornstarch, salt, garlic and onion powders, spices including paprika, coconut milk (dehydrated), sugar, hydrolyzed corn protein, butter powder, whole milk powder, monosodium glutamate, crystallized lemon, orange juice powder, lemongrass guar gum, sunflower oil, natural flavors, oleoresin paprika (coloring), and no more than 2% tricalcium phosphate as anti-caking agent.

The disclosed formulation calls for 30 g spice/1 cup water, cooked and whisked until smooth, with additional melted butter as desired.

Optimal storage condition for this formulation is in strictly sanitary fields and steadily cool, dry temperature at 35F-45F to maintain optimum quality.

The product remains shelf stable for 24 months, but it's recommended to rotate product within 12 months. Product is considered “ready to cook,” but not “ready to eat.”

According to embodiments, there is disclosed a novel enhanced spice system, which comprises, in combination: an evenly distributed flavor, driven by homogeneity of distribution of spicing elements, without increased salt content, whereby a user gets the same taste for the duration of the spice, as disclosed in the Appendix.

According to embodiments, there are disclosed products by the processes herein, wherein the flavor profile is not diminished by packaging.

According to embodiments, there are disclosed products by the processes herein, manufactured in unit-dose, and volume packaging liquid and dry spice.

According to embodiments, there are disclosed products by the processes herein, featuring at least one of cayenne, habanero, and Trinidad scorpion pepper

### Detailed Description of the Inventions

The present inventor has combined base spice systems maintaining formulations with select specialty peppers to formulate a unique and unexpectedly robust flavor profile, which lasts over time and be packaged for single users or high-volume usage, such as at a restaurant, without diminishing said flavor profile.

Likewise, it is not expected that packaging can preserve both the spice profile and can do so in both dry and wet forms. Those skilled in the art likewise understand that the three principal spice choices of the preferred embodiment are selected and exchanged for others. Using the base formulations and at least a favored pepper selection, any specific formulations can be sealed up according to the instant teachings.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

A processor may be provided by one or more processors including, for example, one or more of a single core or multi-core processor (e.g., AMD Phenom II X2, Intel Core Duo, AMD Phenom II X4, Intel Core i5, Intel Core I & Extreme Edition 980X, or Intel Xeon E7-2820).

An I/O mechanism may include a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-Fi card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

Memory according to the invention refers to a non-transitory memory which is provided by one or more tangible devices which preferably include one or more machine-readable medium on which is stored one or more sets of instructions (e.g., software) embodying any one or more of the methodologies or functions described herein. The software may also reside, completely or at least partially, within the main memory, processor, or both during execution thereof by a computer within system, the main memory and the processor also constituting machine-readable media. The software may further be transmitted or received over a network via the network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Memory may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); and optical disks (e.g., CD and DVD disks).

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

1. A novel enhanced spice system, which comprises, in combination:
an evenly distributed flavor driven by homogeneity of distribution of spicing elements, without increased salt content,
whereby a user gets the same taste for the duration of the spice as applied to foods.

2. The novel enhanced spice system of claim 1, further comprising:
a consistent aesthetically durational color, hue, and pigment as perceived by the user, and applied to the subject foods.

3. The novel enhanced spice system of claim 2, having a balanced flavor profile relative to fats, acids, salt and sweetness.

4. The novel enhanced spice system of claim 3, wherein said balance activates all spice system driven taste buds by region in the tongue.

5. The novel enhanced spice system of claim 4, whereby a smooth sauce and consistent flavor profile further comprises adding coconut.

6. The novel enhanced spice system of claim 5, further comprising lemongrass and orange juice for a subtle tangy flavor.

7. A process for making a novel enhanced spice system which comprises, in combination:
combining a base sauce with at least one hot pepper selected from the group of cayenne,
habanero,
Trinidad scorpion pepper,
jalapeno, and,
ghost pepper.

8. The process of claim 7, scaled for single use consumption and high-volume usage, maintaining flavor profile even as packaged in liquid or dry spice forms.

9. The process of claim 8, wherein the flavor profile is not diminished by packaging.

10. The process of claim 9, manufactured in individual packets for single use (unit-dose) and volume packaging ion at least liquid and dry spice forms.

11. The process of claim 10, featuring at least one of cayenne, habanero, and Trinidad scorpion pepper.

12. An app controlling generation of the invention of claim 11, linked to a special purpose computing means and in communication with at least the user and the internet.

13. The App of claim 12, storing extant and updated formulation data and confirming optimized spice levels.
